(19) United States
(12) Patent Application Publication
(10) Pub. No.: US 2023/0325739 A1
(43) Pub. Date: Oct. 12, 2023

(54) METHOD AND DEVICE FOR MANAGING SUPPLY OF A GEOGRAPHIC AREA BY TRANSPORT SERVICE VEHICLES

(71) Applicant: Grabtaxi Holdings Pte. Ltd., Singapore (SG)

(72) Inventors: Anurag BAID, Singapore (SG); Chun Kai PHANG, Singapore (SG); Ashwin MADELIL, Singapore (SG)

(21) Appl. No.: 18/023,593

(22) PCT Filed: Jul. 7, 2021
(86) PCT No.: PCT/SG2021/050396

§ 371 Date: Feb. 27, 2023

(30) Foreign Application Priority Data
Sep. 2, 2020 (SG) 10202008521U

(51) Int. Cl. G06Q 10/0631; G06Q 50/30; G08G 1/00

(52) U.S. Cl. CPC G06Q 10/06315; G06Q 50/30; G08G 1/202

(57) ABSTRACT

A method for managing supply of a geographic area by transport service vehicles comprising: determining, for each sub-area, a demand for transport service vehicles, the sum of demand over the sub-areas forming a total demand; determining, a supply of transport service vehicles in the sub-area, the sum over the sub-areas forming a total supply; calculating a first measure as portion of the total demand that can be met with the total supply when demand in a sub-area may be met with supply in a different sub-area; calculating a second measure as portion of the total demand that can be met with the total supply when demand in a sub-area may only be met with supply in the sub-area; calculating a quality of the distribution of the total supply by a ratio of the first and the second measure and managing the supply of the geographic area depending on the quality.

### TECHNICAL FIELD

Various aspects of this disclosure relate to methods and devices for managing supply of a geographic area by transport service vehicles.

### BACKGROUND

The quality of a transport service largely depends on whether requests for transport can be fulfilled, i.e. whether the supply of transport service vehicles is sufficient to meet the demand. Various approaches for shaping supply such as heatmaps, location insights and dynamic incentives aim to ensure that there is adequate supply by transport service vehicles at the right place and at the right time. However, there is no objective way to measure the ability to position supply where it is needed and higher order metrics such as fulfilment rate or driver utilization need to be used to evaluate whether shaping supply works. Given these higher-order metrics are multi-levered and not impacted by just positioning quality, evaluation as well as attribution of supply shaping approaches can be challenging. This may in particular result in sub-optimal positioning of supply and thus in a lower rate of meeting demand that would be possible with better positioning of the same amount of supply, e.g. number of vehicles.

Accordingly, approaches for managing supply by transport vehicles are desirable which allow improving positioning of supply, e.g. allocation of vehicles to sub-areas of a service area (e.g. a city).

### SUMMARY

Various embodiments concern a method for managing supply of a geographic area by transport service vehicles comprising determining, for each sub-area of a plurality of sub-areas of the geographic area, a demand for transport service vehicles in the sub-area, wherein the sum of demand over the sub-areas forms a total demand, determining, for each sub-area of the plurality of sub-areas, a supply of transport service vehicles in the sub-area of the geographic area, wherein the sum of supply over the sub-areas forms a total supply, calculating a first measure specifying the portion of the total demand that can be met with the total supply when demand in a sub-area may be met with supply in a different sub-area, calculating a second measure specifying the portion of the total demand that can be met with the total supply when demand in a sub-area may only be met with supply in the sub-area, calculating a quality of the distribution of the total supply into the sub-areas by a ratio of the first measure and the second measure and managing the supply of the geographic area by transport service vehicles depending on the calculated quality of the distribution.

According to various embodiments, the first measure specifies the portion of the total demand that can be met if the total supply is optimally distributed to sub-areas in terms of the total demand that can be met.

According to various embodiments, the method comprises, if the calculated quality is below a predetermined threshold, changing the distribution of the total supply to the sub-areas to increase the portion of the total demand that can be met with the total supply when demand in a sub-area may only be met with supply in the sub-area.

According to various embodiments, changing the distribution of the total supply to the sub-areas comprises moving at least some supply from a sub-area in which the supply is above the demand to a sub-area in which the demand is above the supply.

According to various embodiments, changing the distribution of supply comprises controlling one or more vehicles to move from the sub-area in which they are located to a different sub-area.

According to various embodiments, the method comprises, if the calculated quality is below a predetermined threshold, increasing supply at least in a sub-area in which the demand is higher than the supply.

According to various embodiments, the method comprises if the calculated quality is below a predetermined threshold, checking whether the total demand is higher than the total supply, and, if the total demand is higher than the total supply, increasing total supply.

According to various embodiments, increasing supply in a sub-area comprises controlling one or more vehicles to move to the sub-area.

According to various embodiments, the method comprises implementing, before determining the supply of transport service vehicles in the sub-areas, a supply shaping approach and evaluating the performance of the supply shaping approach by the quality of the distribution.

According to various embodiments, the method comprises implementing different supply shaping approaches, evaluating the performances of the supply shaping approaches and selecting the supply shaping approach having the best performance for managing the supply of the geographic area by transport service vehicles.

According to various embodiments, the method comprises controlling transport service vehicles according to the supply shaping approach.

According to various embodiments, the method comprises measuring demand for each sub-area and supply for each sub-area in a plurality of time slots and determining the quality of the distribution for each time slot.

According to various embodiments, the method comprises determining the demand for each sub-area by summing the measured demand for each sub-area over the plurality time slots and determining the supply for each sub-area by summing the measured supply for each sub-area over a plurality of multiple time slots and determining the quality of the distribution for a time period including the plurality of time slots.

According to various embodiments, a server computer including a communication interface, a memory and a processing unit configured to perform the method of any one of the above embodiments is provided.

According to one embodiment a computer program element is provided including program instructions, which, when executed by one or more processors, cause the one or more processors to perform the method of any one of the above embodiments.

According to one embodiment a computer-readable medium is provided including program instructions, which, when executed by one or more processors, cause the one or more processors to perform the method of any one of the above embodiments.

### BRIEF DESCRIPTION OF THE DRAWINGS

The invention will be better understood with reference to the detailed description when considered in conjunction with the non-limiting examples and the accompanying drawings, in which:

FIG. 1 shows a communication arrangement including a smartphone and a server.

FIG. 2 shows a service area of a transport service.

FIG. 3 shows an illustration of determination of a metric for managing supply of a geographic area by transport service vehicles.

FIG. 4 shows exemplary results of metrics for managing supply of a geographic area by transport service vehicles.

FIG. 5 shows a flow diagram illustrating a method for correcting errors in map data according to an embodiment.

FIG. 6 shows a server computer according to an embodiment.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the devices or methods are analogously valid for the other devices or methods. Similarly, embodiments described in the context of a device are analogously valid for a vehicle or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

An e-hailing app, typically used on a smartphone, allows its user to hail a taxi (or also a private driver) through his or her smartphone for a trip.

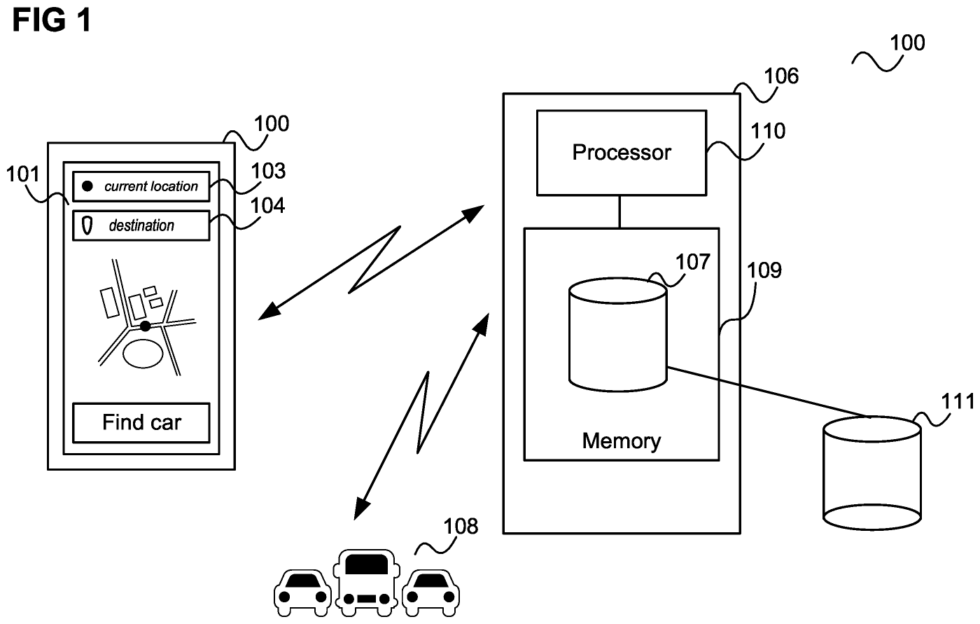

FIG. 1 shows a communication arrangement including a smartphone 100 and a server (computer) 106.

The smartphone 100 has a screen showing the graphical user interface (GUI) of an e-hailing app that the smartphone's user has previously installed on his smartphone and has opened (i.e. started) to e-hail a ride (taxi or private driver).

The GUI 101 includes a map 102 of the user's vicinity (which the app may determine based on a location service, e.g. a GPS-based location service). Further, the GUI 101 includes a box for point of departure 103 (which may be set to the user's present location obtained from location service) and a box for destination 104 which the user may touch to enter a destination (e.g. opening a list of possible destinations). There may also be a menu (not shown) allowing the user to select various options, e.g. how to pay (cash, credit card, credit balance of the e-hailing service). When the user has selected a destination and made any necessary option selections, he or she may touch a “find car” button 105 to initiate searching of a suitable car.

For this, the e-hailing app communicates with the server 106 of the e-hailing service via a radio connection. The server 106 includes a database 107 having information about the current location of registered vehicles 108 (i.e. vehicles which form the supply of the transport service), about when they are expected to be free, about traffic jams etc. From this, a processor 110 of the server 106 selects the most suitable vehicle (if available, i.e. if the request can be fulfilled) and provides an estimate of the time when the driver will be there to pick up the user, a price of the ride and how long it will take to get to the destination. The server communicates this back to the smartphone 100 and the smartphone 100 displays this information on the GUI 101. The user may then accept (i.e. book) by touching a corresponding button. If the user accepts, the server 106 informs the selected vehicle 108 (or, equivalently, its driver), i.e. the vehicle the server 106 has allocated for fulfilling the transport request.

It should be noted while the server 106 is described as a single server, its functionality, e.g. for providing an e-hailing service for a whole city, will in practical application typically be provided by an arrangement of multiple server computers (e.g. implementing a cloud service). Accordingly, the functionality described in the following provided by the server 106 may be understood to be provided by an arrangement of servers or server computers.

Whether a request by the smartphone 100 for a transport can be fulfilled depends largely on whether a vehicle of the e-hailing service is sufficiently near, i.e. whether the area in which the user is located is sufficiently supplied with vehicles of the e-hailing service (or more generally transport service). For monitoring and managing supply accordingly, with the aim of having a high rate of requests that can be served, the server computer 106 may store in the data base 107 information about supply and demand in the service area, e.g. per sub-area of the service area.

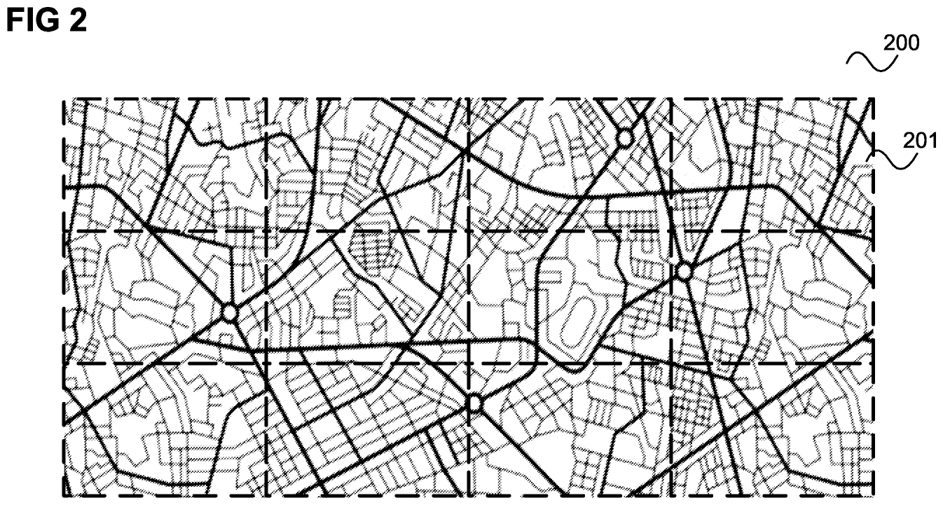

FIG. 2 illustrates a service area 200 of a transport service.

The service area 200 is in this example the area of a city which is for simplicity rectangular but may of course have any form like a real city. The roads and places where one may go form a network so the service area 200 can also be considered as such a network as far as a transport service is concerned.

The service area 200 is sub-divided into sub-areas 201 indicated by dashed boxes. For example, each sub-area corresponds to a geohash of a certain number of digits (for example 5 digits). When in the following reference to a geohash is made a geohash of this number of digits (e.g. 5) is meant.

It is assumed that a request for a request in a sub-area 201 can only be fulfilled if the supply in the sub-area 201 is at least the total demand for vehicles (including the request) in the sub-area 201. Thus, whether requests can be fulfilled not only depends on the total supply (e.g. the total number of vehicles) in the whole service area 200 but also how the supply is distributed into the sub-areas 201.

According to various embodiments, a measure denoted as supply positioning score is used which allows measuring the quality of supply positioning in the service area 200. It thus in particular allows measuring the success of supply shaping approaches (such as incentives) via experimentation. Higher-order metrics do not allow this since they are multi-levered and not only impacted by positioning quality.

According to various embodiments, a method of managing supply of a geographic area by transport service vehicles includes measuring network health (in terms of sufficient supply) by city-hour, which provides information about (i) adequacy of level of supply (is more supply in a service area at a particular hour needed?), (ii) quality of positioning (Has supply positioning worsened?). The method of managing supply may be performed by an operator (or operation team) of the transport service, e.g. by means of server 106, which may be configured to perform the method. It should be noted that the term transport service is not merely to be understood as a transport of passengers (i.e. a taxi or e-hailing service) but also includes transport of food and/or beverages (i.e. the transport service may be a food/beverage service) letters and parcels (i.e. may be a mail transport service) etc.

The supply positioning score (SPS) is a network-level (i.e. service area-level) metric which measures the quality of supply positioning by evaluating the supply and demand levels per sub-area 201 and per time interval (e.g. every minute), in other words for each geohash-one-minute-interval. In order to compute the SPS, two metrics called present positioning efficiency (PPE) and maximum achievable efficiency (MAE) are used. The supply positioning score combines PPE and MAE to provide a network-level quality assessment for the positioning of supply.

Table 1 gives an overview over MAE, PPE and SPS.

TABLE 1

| | Value | Direc- | |
|---|---|---|---|
| Metric | Range | tion | Description |
| Maximum | 0 to 1 | Higher | Estimate of the maximum level of |
| Achievable | | the | demand that can be met given the |
| Efficiency | | better | current level of supply. For example, a |
| (MAE) | | | decreasing ME may be considered as an |
| | | | indication that total supply in the |
| | | | service area should be increased. |
| Present | 0 to 1 | Higher | Estimate of the current level of demand |
| Positioning | | the | that can be met given current |
| Efficiency | | better | positioning of supply. Assumes ideal |
| (PPE) | | | allocation |
| Supply | 0 to 1 | Higher | Estimate of the efficiency of the present |
| Positioning | | the | positioning (i.e. positioning in a certain |
| Score (SPS) | | better | time slot) relative to ideal positioning |
| | | | (i.e. positioning which would lead to |
| | | | MAE). Given by the ratio of PPE and |
| | | | MAE. Assumes ideal allocation (e.g. no |
| | | | waste of passenger seats, no empty |
| | | | rides, etc.) |

In the following, exemplary formulas for determining MAE, PPE and SPS for a service area are given, in each case for a certain time slot (indicated by index t, e.g. of with a length of one minute) and for a longer time period, i.e. an aggregation of time slots (indicated by index agg). The following notation is used:
G is the set of all geohashes of the service area, i.e. of the geohashes of all sub-areas of the service area
T is the set of time-slots within the considered time period (aggregation of time slots) for the aggregated versions of MAE, PPE and SPS
s_{g,t}=supply in the sub-area with geohash g in one-minute time interval t
d_{g,t}=demand in the sub-area with geohash g in one-minute time interval t
MAEₜ=maximum achievable efficiency given ideal supply positioning in time slot t
MAE_{agg}=max achievable efficiency within time period (averaged over T time slots)
PPEₜ=present positioning efficiency given current supply positioning and demand level in time slot t
PPE_{agg}=positioning efficiency given current supply positioning and demand level in time period (averaged over T time slots)
SPSₜ=present positioning score given current supply positioning in time slot t
SPS_{agg}=positioning score in time period (averaged over T time slots)

Determining SPSₜ and SPS_{agg} comprises getting levels of supply for each time slot t and geohash (e.g. the number of drivers currently being idle (i.e. waiting and being available for an incoming booking) plus the number of drivers who are currently in-transit for the transport service but available for subsequent bookings), and demand (based on Unique Check Price) for each time slot t and geohash and computing PPE, MAE and SPS according to the following formulas. The Unique Check Price refers to number of requests where a customer checked the price of the transport service, the intention being to capture all expressions of interest in the transport service, not just actual bookings.

$${MAE}_{t} = min ( {\sum }_{g = 1}^{G} {s}_{g , t} , {\sum }_{g = 1}^{G} {d}_{g , t} ) / {\sum }_{g = 1}^{G} {d}_{g , t}$$

$${MAE}_{agg} = {\sum }_{t = 1}^{T} min ( {\sum }_{g = 1}^{G} {s}_{g , t} , {\sum }_{g = 1}^{G} {d}_{g , t} ) / {\sum }_{t = 1}^{T} {\sum }_{g = 1}^{G} {d}_{g , t}$$

$${PPE}_{t} = {\sum }_{g = 1}^{G} min ( {s}_{g , t} , {d}_{g , t} ) / {\sum }_{g = 1}^{G} {d}_{g , t}$$

$${PPE}_{agg} = {\sum }_{t = 1}^{T} {\sum }_{g = 1}^{G} min ( {s}_{g , t} , {d}_{g , t} ) / {\sum }_{t = 1}^{T} {\sum }_{g = 1}^{G} {d}_{g , t}$$

$${PS}_{t} = {PPE}_{t} / {MAE}_{t} = {\sum }_{g = 1}^{G} min ( {s}_{g , t} , {d}_{g , t} ) / min ( {\sum }_{g = 1}^{G} {s}_{g , t} , {\sum }_{g = 1}^{G} {d}_{g , t} )$$

$${PS}_{agg} = {\sum }_{t = 1}^{T} {\sum }_{g = 1}^{G} min ( {s}_{g , t} , {d}_{g , t} ) / {\sum }_{t = 1}^{T} min ( {\sum }_{g = 1}^{G} {s}_{g , t} , {\sum }_{g = 1}^{G} {d}_{g , t} )$$

It should be noted that the mathematical formulations of MAE, PPE and SPS are agnostic of the aggregation period (of T time slots). They are thus easily aggregable to any level of temporal granularity (as well as spatial granularity, since the size of sub-areas may be freely chosen). For example, the time period over which the aggregated values are determined may be a week (T=7*number of time slots per day), Month (T=30*number of time slots per day), Quarter (T=90*number of time slots per day) or Yearly (T=365*number of time slots per day) level.

Regarding spatial granularity, for practical use, a service area (“network”) is for example defined as all geohashes (with a certain number of digits) within a city. However, the above mathematical formulation also allows for other definitions. For example, it is possible to distinguish between the center of a city (as one service area) and the whole city (as another service area).

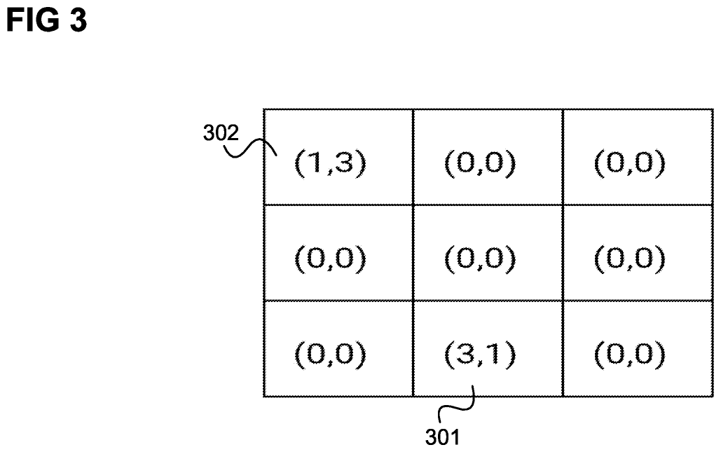

FIG. 3 shows an illustration of determination of SPS.

Each box of the 3×3 pattern of FIG. 3 represents a sub-area (e.g. the 3×3 pattern of FIG. 3 corresponds to 3×3 of the service areas 201 of FIG. 2).

For each box, a value pair (x,y) is indicated which means that at a current time t, there are x units of supply and y units of demand within the sub-area.

In this example:
PPE=(1+1)/(3+1)=50%. Thus, assuming ideal allocation, 50% of the demand can be met given current quality of positioning.
MAE=(1+3)/4=100%. Thus, assuming ideal allocation and ideal positioning, 100% of demand can be met. Ideal allocation for example means that if the unit of supply are seats and the units of supply are passengers, that vehicles are always fully filled with passengers, that there are no empty rides, etc. For an undersupplied service area, MAE will be less than one.
SPS=PPE/MAE=50%. Assuming ideal allocation, this gives the present positioning quality relative to ideal positioning quality.
   It should be noted that demand can be fully met by two supply units from box 301 to box 302 (then PPE would become equal to MAE and PS would become 1). So, from PS being smaller than 1 server 106 may derive that positioning of demand could be improved (to meet more demand) and may for example redistribute supply by moving two supply units (e.g. two vehicles) from box 301 to box 302. For this, server 106 may send corresponding messages to vehicles 108 of the sub-area corresponding to box 301 to send them to the sub-area corresponding to box 302.

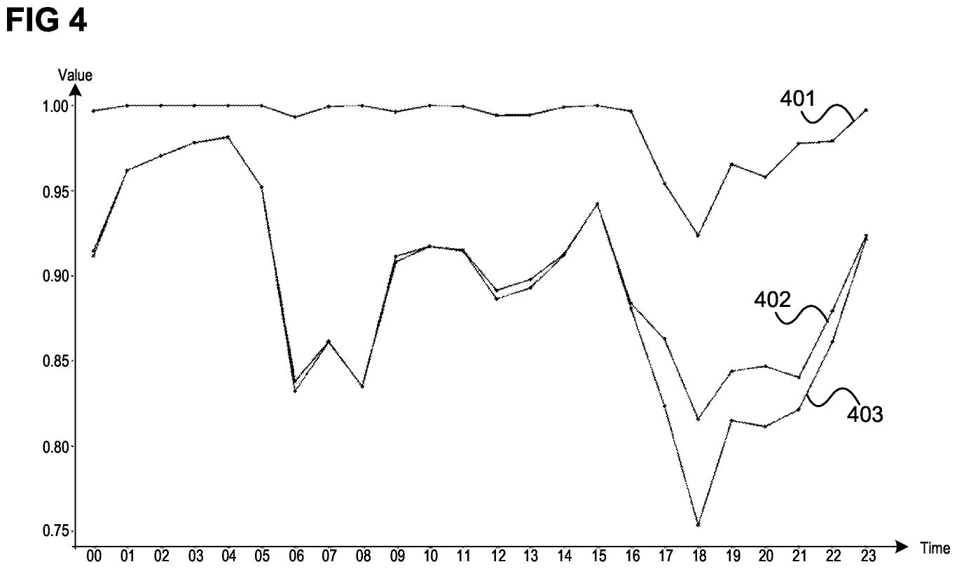

FIG. 4 shows exemplary results for determining PPE, MAE and SPS.

The values increase from bottom to top according to the vertical axis and time increases from left right along the horizontal axis. Values for PPE, MAE and SPS are shown for one day (from 0 am to 23 pm). The top curve 401 indicates the values of MAE. The middle curve 402 indicates SPS and the bottom curve 403 indicates PPE.

The middle curve 402 and the bottom curve 403 are very similar for certain times but it should be noted that PPE is always equal or below SPS (since MAE is at most 1) so the bottom curve 403 corresponds to PPE.

It can be seen that the maximum achievable efficiency (MAE) is well below 100% from 5 pm onwards. From this, the server 106 may infer that it can never meet 100% of the demand despite ideal positioning. It may thus for example initiate non real-time: supply shaping approaches to ensure adequate supply quanta in the evening.

Further, it can be seen that supply positioning score is very low during morning and evening peak hours, From this, the server 106 may infer that positioning quality is especially bad during morning peak hours. It may thus initiate real-time supply shaping approaches to position vehicles 108 better.

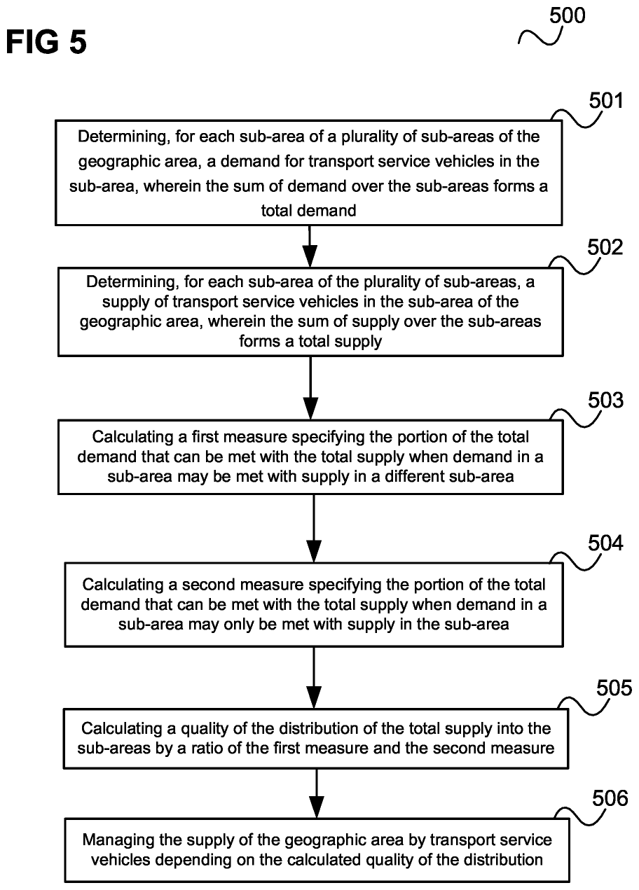

In summary, according to various embodiments, a method is provided as illustrated in FIG. 5.

FIG. 5 shows a flow diagram 500 illustrating a method for managing supply of a geographic area (i.e. a transport service area) by transport service vehicles.

In 501, for each sub-area of a plurality of sub-areas of the geographic area, a demand for transport service vehicles in the sub-area is determined, wherein the sum of demand over the sub-areas forms a total demand.

In 502, for each sub-area of the plurality of sub-areas, a supply of transport service vehicles in the sub-area of the geographic area is determined, wherein the sum of supply over the sub-areas forms a total supply.

In 503, a first measure is calculated specifying the portion of the total demand that can be met with the total supply when demand in a sub-area may be met with supply in a different sub-area.

In 504, a second measure is calculated specifying the portion of the total demand that can be met with the total supply when demand in a sub-area may only be met with supply in the sub-area.

In 505, a quality of the distribution of the total supply into the sub-areas is calculated by a ratio of the first measure and the second measure.

In 506, the supply of the geographic area is managed by transport service vehicles depending on the calculated quality of the distribution.

According to various embodiments, in other words, a ratio between the rate of demand that can be met using the actual positioning and the rate of demand that could be met using optimal positioning (i.e. distribution of supply to sub-areas that would maximize the rate of demand that can be met) is determined. According to this measure, positioning or supply may be changed, e.g. supply may be re-distributed between sub-areas or overall supply may be increased.

This measure (corresponding to the supply positioning score in the examples above) for example allows measuring the success of supply shaping approaches (e.g. by performing experiments or in practical application). Consequently, the evaluation as well as attribution of supply shaping approach is possible and a supply shaping approach may be selected which fits (works well for) the considered service area (e.g. city).

For example, network health may be measured (in terms of sufficient supply), e.g. by city-hour, and the adequacy of level of supply (is more supply needed in a particular city at a particular hour?) and the quality of positioning (has supply positioning improved or worsened?) may be determined. Supply or positioning or both may then be adapted, if necessary, to increase the ratio between the rate of demand that can be met using the actual positioning and the rate of demand that could be met using optimal positioning (e.g. if the determined ratio is below a predetermined threshold, e.g. 0.8, 0.85 or 0.9).

Supply is for example in units of transport vehicles and supply in a sub-area means the transport vehicles located in the sub-area in the time slot (or a certain reference time of the time slot, e.g. start time or center time). Thus, supply in a sub-area in a time slot is for example a number of transport vehicles in the sub-area in the time slot (which are registered with the transport service and either idle or serving a request). Demand in a sub-area in a time slot for example means a number of requests for a ride originated in the sub-area during the time slot.

The method of FIG. 5 may be part of a method for controlling a fleet of vehicles.

The transport service vehicles may for example be autonomous vehicles. Controlling a vehicle to move to a sub-area or to move to a service area (to increase supply in the sub-area or service area) may thus for example mean instructing a vehicle controller of a vehicle to move to the sub-area or service area (without the need of a human user moving the vehicle to the sub-area or service area).

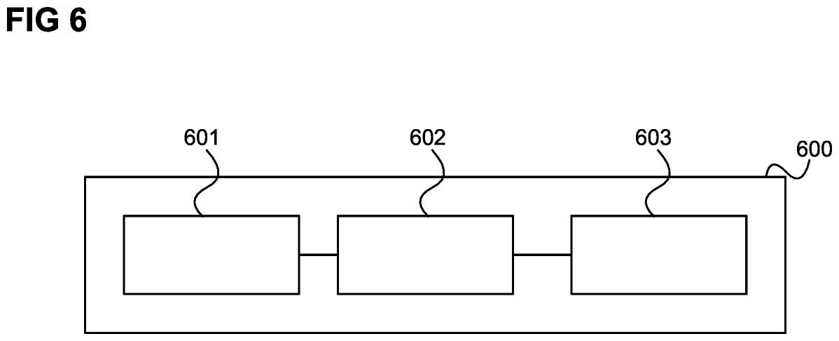

The method of FIG. 5 is for example carried out by a server computer as illustrated in FIG. 6.

FIG. 6 shows a server computer 600 according to an embodiment.

The server computer 600 includes a communication interface 601 (e.g. configured to receive data regarding demand and supply. The server computer 600 further includes a processing unit 602 and a memory 603. The memory 603 may be used by the processing unit 602 to store, for example, data to be processed, such as information about demand and supply. The server computer is configured to perform the method of FIG. 5.

The methods described herein may be performed and the various processing or computation units and devices described herein may be implemented by one or more circuits.

In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for managing supply of a geographic area by transport service vehicles comprising:
determining, for each sub-area of a plurality of sub-areas of the geographic area, a demand for transport service vehicles in the sub-area, wherein a sum of demand over the sub-areas forms a total demand;
determining, for each sub-area of the plurality of sub-areas, a supply of transport service vehicles in the sub-area of the geographic area, wherein a sum of supply over the sub-areas forms a total supply;
calculating a first measure specifying a portion of the total demand that can be met with the total supply when demand in a sub-area may be met with supply in a different sub-area;
calculating a second measure specifying a portion of the total demand that can be met with the total supply when demand in a sub-area may only be met with supply in the sub-area;
calculating a quality of a distribution of the total supply into the sub-areas by a ratio of the first measure and the second measure; and
managing the supply of the geographic area by transport service vehicles depending on the calculated quality of the distribution.

2. The method of claim 1, wherein the first measure specifies the portion of the total demand that can be met if the total supply is optimally distributed to sub-areas in terms of the total demand that can be met.

3. The method of claim 1, comprising, if the calculated quality is below a predetermined threshold, changing the distribution of the total supply to the sub-areas to increase the portion of the total demand that can be met with the total supply when demand in a sub-area may only be met with supply in the sub-area.

4. The method of claim 3, wherein changing the distribution of the total supply to the sub-areas comprises moving at least some supply from a sub-area in which the supply is above the demand to a sub-area in which the demand is above the supply.

5. The method of claim 3, wherein changing the distribution of the total supply to the sub-areas comprises controlling one or more vehicles to move from the sub-area in which they are located to a different sub-area.

6. The method of claim 1, comprising, if the calculated quality is below a predetermined threshold, increasing supply at least in a sub-area in which the demand is higher than the supply.

7. The method of claim 1, comprising, if the calculated quality is below a predetermined threshold, checking whether the total demand is higher than the total supply, and, if the total demand is higher than the total supply, increasing total supply.

8. The method of claim 6, wherein increasing the supply at least in the sub-area comprises controlling one or more vehicles to move to the sub-area.

9. The method of claim 1, comprising implementing, before determining the supply of the transport service vehicles in the sub-area, a supply shaping approach; and evaluating a performance of the supply shaping approach by the quality of the distribution.

10. The method of claim 1, comprising implementing different supply shaping approaches; evaluating performances of the supply shaping approaches; and selecting a supply shaping approach having a best performance for managing the supply of the geographic area by the transport service vehicles.

11. The method of claim 10, comprising controlling the transport service vehicles according to the supply shaping approach.

12. The method of claim 1, comprising measuring demand for each sub-area and supply for each sub-area in a plurality of time slots and determining the quality of the distribution for each time slot.

13. The method of claim 12, comprising determining the demand for each sub-area by summing the measured demand for each sub-area over the plurality of time slots; determining the supply for each sub-area by summing a measured supply for each sub-area over the plurality of time slots; and determining the quality of the distribution for a time period including the plurality of time slots.

14. A server computer comprising a radio interface, a memory interface and a processing unit configured to perform the method of claim 1.

15. A computer program element comprising program instructions, which, when executed by one or more processors, cause the one or more processors to perform the method of claim 1.

16. A computer-readable medium comprising program instructions, which, when executed by one or more processors, cause the one or more processors to perform the method of claim 1.
